(19) United States
(12) Patent Application Publication
(10) Pub. No.: US 2008/0007426 A1
(43) Pub. Date: Jan. 10, 2008

(54) Modified use of a standard message protocol for inter-module communications within a utility meter

(75) Inventor: Gary Morand, Berkeley Lake, GA (US)

Correspondence Address: DORITY & MANNING, P.A., POST OFFICE BOX 1449, GREENVILLE, SC, 29602-1449, US

(73) Assignee: Itron, Inc, Liberty Lake, WA (US)

(21) Appl. No.: 11/811,887

(22) Filed: Jun. 12, 2007

Related U.S. Application Data
(60) Provisional application No. 60/813,140, filed on Jun. 13, 2006.

(51) Int. Cl. G08C 15/06

(52) U.S. Cl. 340/870.02

(57) ABSTRACT

A utility meter may comprise a plurality of modules providing functionality such as metrology, communications, registering power consumption, and other meter personality features. The modules may be connected to one another and configured to communicate within the meter (inter-module communications) using a standards-based protocol that, for intra-meter communications, omits unneeded information. For example, for an ANSI C12.22 BLURT message sent within the meter, the “Calling ApTitle” field and/or the “End Class Device” field and/or the “Write Service Request” field may be omitted. The omitted field(s) are added later by modules in the case of intra-meter messages relayed to an outside, standards-compliant network.

### PRIORITY CLAIM

This application claims the benefit of previously filed U.S. Provisional Patent Application entitled “MODIFIED USE OF A STANDARD MESSAGE PROTOCOL FOR INTER-MODULE COMMUNICATIONS WITHIN A UTILITY METER,” assigned U.S. Ser. No. 60/813,140, filed Jun. 13, 2006, and which is fully incorporated herein by reference for all purposes.

### FIELD OF THE INVENTION

This disclosure generally relates to utility meters, and particularly to the modified use of a standard communications protocol for communication between functionality modules within a utility meter, such as an electricity meter.

### BACKGROUND OF THE INVENTION

The general object of metrology is to monitor one or more selected physical phenomena to permit a record of monitored events. As such, a primary goal for any measurement technology is to provide for accurate, precise measurements in a timely and economic manner. Such basic purpose of metrology can be applied to a variety of metering devices used in a number of contexts. Utility meters are one such technology, and find use in the many varied circumstances which call for measurement of data pertaining to such as consumption and/or generation of electricity, water, gas, oil, or other commodities.

More particularly concerning electricity meters, mechanical forms of registers have been historically used for outputting accumulated electricity consumption data. Such an approach provided a relatively dependable field device, especially for the basic or relatively lower level task of simply monitoring accumulated kilowatt-hour consumption.

The foregoing basic mechanical form of register was typically limited in its mode of output, so that only a very basic or lower level metrology function was achieved. Although earlier utility meters operated successfully for their purposes on a mechanical basis, the modern trend has led towards digital or solid-state meters. The use of electronics in the utility metering context has allowed for a great deal of additional forms of data collection and manipulation.

In the context of electricity meters specifically, for a variety of management and billing purposes, it has become desirable to obtain usage data beyond the basic kilowatt-hour consumption readings available with many electricity meters. For example, additional desired data may include rate of electricity consumption, or may include date and time of consumption (so-called “time of use” data). Solid state devices provided on printed circuit boards, for example, utilizing programmable integrated circuit components, have provided effective tools for implementing many of such higher level monitoring functions desired in the electricity meter context.

In addition to the beneficial introduction of electronic forms of metrology, a variety of electronic registers have been introduced with certain advantages. Still further, other forms of data output have been introduced and are beneficial for certain applications. For example, utility meters may be configured to communicate with additional communications equipment external thereto, such as a specialized network or equipment which makes use of an existing pathway such as the internet, including wired transmissions, data output via radio frequency transmission, pulse output of data, and telephone line connection via such as modems and/or wireless (such as cellular) linkups. Such communications linkages may be provided in order to allow for remote collection of electricity consumption data without the need for a technician to physically approach and read the meter display or otherwise obtain data from the meter.

For instance, in the context of electricity metering, voltage and current values can be collected and converted into electronic form by circuitry such as analog-to-digital (A/D) converters. The voltage and current values can then be manipulated by a processor to calculate various forms of energy measurement, such as Watts, Volt-Amps (VA), or Volt-Amps Reactive (Vars). The calculated energy measurements can then be further manipulated, stored, and/or transmitted electronically to other equipment and locations for collection and analysis purposes. It is to be understood that other values and/or data, such as temperature or status, may be similarly collected, converted, manipulated, stored, and/or transmitted. Hence, any such other values and/or data could in accordance with the present subject matter, also come to be represented in a given message, either of an inter-module nature (i.e. within a meter) or of a nature external to a meter, and the present subject matter is equally applicable to such contexts.

In order to streamline communications between networked utility meters (whether electricity meters or otherwise), various standards have been proposed and adopted so that devices made by different entities or from various sources may communicate using common protocol(s). For instance, ANSI (American National Standards Institute) standard C12.22 specifically addresses one-way messages in such contexts, and defines a so-called “BLURT” message as follows:
BLURT=Calling ApTitle+End device class+Write Service Request+Table ID+Table Count+Table data+Checksum
where the Calling ApTitle uniquely identifies the message source and the End Device Class defines the manufacturer and nature of the message; the actual content of the message is contained in the “table data” portion of the BLURT.

Various standards also address another aspect of electronics-based utility meters, namely the increasing division of functionality into independent modules. For instance, in ANSI C12.22, “communications module” is defined as a hardware module that attaches a C12.22 device to a C12.22 network segment, with the communications module being physically and logically distinct from the C12.22 device (although the communications module may be housed in the C12.22 device enclosure).

Solid-state electricity meters also can utilize modules of various formats, such as “option boards” which provide for enhanced functionality. Such functionality can include the ability to make higher-order measurements such as demand and time-of-use (TOU) metering, or additional memory storage, for instance.

Various disclosures concern designs relating to communications systems or devices associated with various forms of metrology, including for example the following U.S. patents: U.S. Pat. No. 6,657,552 B2 to Belski et al. for System and Method for Communication and Control of Automated Meter Reading; U.S. Pat. No. 6,357,034 B1 to Muller et al. for Data Communications Method and the Use of the Method in a System for Remotely Reading Meters; U.S. Pat. No. 6,100,817 to Mason, Jr. et al. for Fixed Network RF Communications Complaint [sic] With CEBUS Protocol; U.S. Pat. Nos. 7,209,840 and 6,836,737, both to Petite et al. for Systems and Methods for Providing Remote Monitoring of Consumption for a Utility Meter; and U.S. Pat. Nos. 4,504,831 and 4,707,852, both to Jahr et al. for Utility Usage Data and Event Data Acquisition System.

The disclosures of the foregoing United States Patents are for all purposes hereby fully incorporated into this application by reference thereto.

Despite innovation in utility meter design, components, and networking capabilities and the prevalence of standards, there is an ever-present need for increased efficiency in meter design and manufacturing. In addition, while various aspects and alternative embodiments may be known in the field of utility metering, no one design has emerged that generally encompasses the characteristics and other desirable features associated with utility metering technology as herein presented.

### SUMMARY OF THE INVENTION

In view of the recognized features encountered in the prior art and addressed by the present subject matter, improved apparatus and corresponding methodology is provided in conjunction with internal and external electricity meter communications.

In a broader present object, improved utility metering methodology and corresponding apparatus are provided for efficient handling of communications. More particularly, it is a present object to make use of a modified standard protocol when concerning communications between boards or sections within a utility meter without losing the advantages and abilities of using the subject standard protocol for communications between such utility meter and other meters and/or communications devices.

Still further, it is a more specific present object to provide such improved methodology and corresponding apparatus in the context of embodiments of electricity meters, which make modified use (in one of various present ways) of ANSI standards for internal communications, but which make use of normal ANSI standards for external communications such that the subject electricity meter is appropriately rated for interaction with a particular ANSI standards-based network.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents including combinations of features, parts, or steps or configurations thereof not expressly shown in the Figures or stated in the detailed description of such Figures.

In one present exemplary embodiment, a utility meter and corresponding methodology are disclosed, wherein messages between modules internal to the meter are formatted based on a modified version or versions of external communication standards, such as by omitting device-specific identifiers. For instance, in accordance with present subject matter, the metrology board of an electricity meter may utilize a modified ANSI C12.22 BLURT message for internal transmissions to other meter components, such as a register board, personality module, or communications module. Such internal BLURT message in accordance with the present subject matter may differ from the standard definition by for example containing a null ApTitle or for example by omitting the ApTitle entirely. The other component(s) or module(s) of the meter may be configured in accordance with the present subject matter to recognize the internal message and to add other formatting as needed, depending on the implementation of the modified message, for standards-compliant external transmission of messages, such as by adding a unique ApTitle to an internal-based BLURT message before transmission thereof on an ANSI C12.22 rated network.

In addition to such embodiments, for example, leaving off or adding the ApTitle for internal and external use of the message, respectively, other embodiments may be practiced where other component aspects of a message are variously omitted and/or added. For example, the End Class Device and/or Write Service Request data may also be included or not, in accordance with the same aspects of the present methodology, and each such variation of the data being not included or alternately added should be understood to be a further embodiment of the present subject matter.

In another present exemplary embodiment, a utility meter is provided which makes modified use of ANSI standards for internal communications, but which make uses of normal ANSI standards for external communications, for interaction with an ANSI standards-based network. Such an improved utility meter preferably comprises a metrology board, having a modified ANSI C12.22 BLURT message output which omits preselected device-specific data, for internal transmissions to other components within said meter; and at least one other component within such meter. Said at least one other component preferably comprises one of a register board, personality module, options module, or communications module, and is adapted for receiving such modified ANSI C12.22 BLURT message output of the metrology board, and processing such modified ANSI C12.22 BLURT message for emission external to the meter.

Yet another present exemplary embodiment relates to a metrology system, comprising a first device configured to collect data corresponding to utility consumption data; and a second device configured to receive data from the first device using a fully-compliant standard communications protocol. With such a system, advantageously such first device also preferably comprises a plurality of component subsystems configured for communications among themselves using a non-fully compliant standard protocol subset of the fully compliant standard protocol.

It is to be understood that the present subject matter equally relates to corresponding methodology, as well as associated systems and devices. One example of present methodology relates to a method for providing fully compliant standard protocol inter-communications among plural associated devices. Such present exemplary method preferably comprises providing a plurality of devices, each device comprising a plurality of subsystems, at least one selected subsystem of each respective device having communications capabilities with one or more of the other subsystems in each such respective device; selecting a standard communications protocol for communications among the plural associated devices, the standard communications protocol including plural segments; transmitting data among subsystems of each device using a non-fully compliant standard protocol subset of the plural segments of the selected standard communications protocol; combining data with the non-fully compliant standard protocol subset to produce a fully compliant standard protocol message for each respective device; and transmitting the fully compliant standard protocol message externally from each respective device.

Still further present exemplary subject matter relates to a communications system, comprising a first device comprising a plurality of component subsystems; and a second device, such first and second devices configured for communications using a fully compliant standard protocol, and with the plurality of component subsystems of such first device are configured for communications among themselves using a non-fully compliant standard protocol subset of the fully compliant standard protocol.

Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth more particularly in the remainder of the specification, which makes reference to the appended Figures, in which:

FIG. 1 is generally a top and side isometric view of an exemplary utility meter which may be configured in accordance with the present subject matter;

FIG. 2 illustrates a schematic representation of various exemplary configurations of utility meters in accordance with the present subject matter; and

FIG. 3 represents exemplary present methodology or process embodying modified use in accordance with the present subject matter of a standard message protocol.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with corresponding methodology and apparatus for utility meters, and, in particular, electricity meters which are rated for interaction with other components or technologies per a standard communications protocol.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

Moreover, it should be appreciated that, whereas the general discussion herein relates more specifically to electricity meters and specific types of communication standards, including ANSI C12.22 message standards, such is not a limitation of the present technology. In general the present technology may be applied to any form of communications standard protocol where elimination or reduction of one or more message fields for intra-meter communications may be desirable.

Reference will now be made in detail to present embodiments of the present subject matter, one or more examples of which are illustrated in the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the subject matter disclosed herein includes modifications and variations as come within the scope of the appended claims and their equivalents.

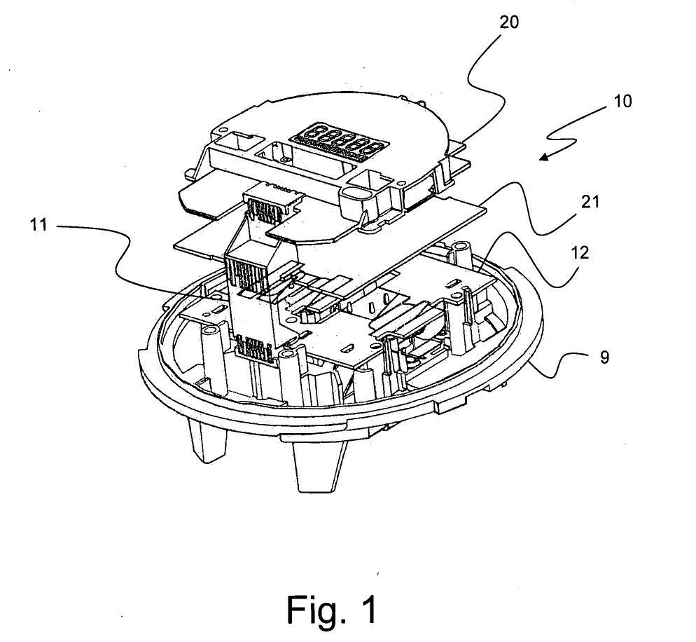

FIG. 1 illustrates a perspective view of an exemplary utility meter, in this case an electricity meter 10 including a number of electronic boards or sections, each providing specific functional features. However, in other embodiments, functionality may be provided by one or more boards, depending upon a particular implementation. Therefore, for the remainder of this disclosure, such capabilities may also be referred to in the context of “modules,” where “modules” include single-board or multi-board hardware implementations of specified functionality.

With reference to FIG. 1, there is illustrated generally side and bottom isometric views of the exemplary utility meter 10 incorporating solid state circuitry which in turn may variously incorporate the present subject matter with reference to intra-module/inter-meter communications (i.e., communications within the meter) as well as with reference to communications external to the meter. Solid state devices provided on printed circuit boards, such as utilizing programmable integrated circuit components or the like, may be used example, for implementing the present modified communications protocol otherwise discussed in the present specification. While a specific present example of such is illustrated, which happens to use three different circuit boards, it is to be understood by those of ordinary skill in the art that the present subject matter may be practiced in a wide variety of alternative configurations, such as involving other numbers of circuit boards and/or interconnections thereof. All such variations are intended to come within the scope of the present subject matter, as those of ordinary skill in the art will understand other general aspects of electricity meters into which the present subject matter may be incorporated, which general aspects form no particular part of the present subject matter.

In the present example represented in FIG. 1, exemplary utility meter 10 includes a base member 9 for interfacing the meter to a socket, as is well known to those of ordinary skill in the art without additional explanation. Such base member 9 may as shown be attached a printed circuit board (PCB) 12 that may correspond to, for example, a metrology Printed Wiring Board (PWB). Such metrology module 12 may include sampling and other digital circuitry, and preferably is constructed to measure current(s) and/or voltage(s) as applicable to a particular installation, and to convert the same to digital data by using a microcontroller or other electronic processor(s) with associated memory and additional components. Additional site data may be obtained, for example, such as temperature. Metrology module 12 may be configured and programmed to calculate energy consumption data such as watts consumed over a sampling interval, based on the digital current and voltage measurements. In general, the present subject matter would preferably be implemented in calculations to be conducted in such metrology section/functionality of the meter, based on inputs thereto otherwise derived from association of the meter with an installation (details of which are well known to those of ordinary skill in the art, and not otherwise shown herewith as they form no particular aspect of the present subject matter).

A connector generally 11 is represented as such may be attached to connector traces on an edge portion of PCB 12. In a similar manner, other associated boards of electricity meter 10 may be implemented as shown, or they may be implemented in some other fashion, details of which form no particular present aspect. For example, such as a representative Register Printed Wiring Board corresponding to PCB 20 may be plugged into another representative slot of the exemplary connector 11. Still further by way of example only, an Options Printed Wiring Board corresponding to a PCB 21 may be plugged into a corresponding slot of the representative connector 11.

As represented, each of the several slot positions of exemplary connector 11 may provide electrical connections and/or support for the PCB plugged into the slots, and via such electrical connections through which data and/or circuit board power may be conducted among the three exemplary boards as desired in a given embodiment. The exemplary utility meter generally 10, once assembled, may be protected by placement of a cover (such as made of glass or Plexiglas—not shown but well known to those of ordinary skill in the art) over the various circuit boards (regardless of the number used), and into sealing engagement with the utility meter base 9 (also as well understood in the art).

With metrology module 12 connected via connector 11 to the two exemplary additional modules (namely, register module 20 and an option module 21 as per the illustration of FIG. 1) such register module 20 may, for example, comprise a display, memory, processor, and additional components configured to accumulate and store electricity measurement and provide visual data via such display, all as generally understood by those of ordinary skill in the art without requiring additional explanation. For example, the register module 20 may be programmed to monitor the total kilowatt hours (kwh) consumed and to display the same. Other functionality, for example site installation diagnostics based on voltage and current magnitudes and phases, may be built into various modules, for example, including either of the register module 20 or the option module 21, or both. The register module 20 may further include a port for external communications, for example an optical port, and can further provide for security and access control. In such manner, for example, through use of such optical port, or otherwise, energy consumption data can be read or reset or the meter reprogrammed.

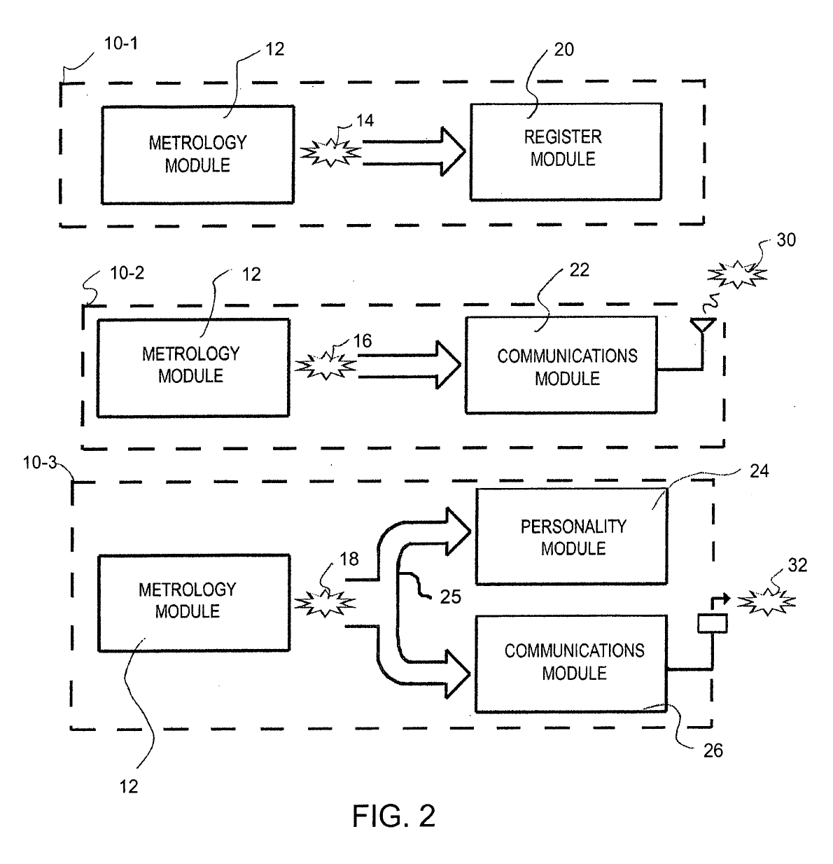

Option module 21 is meant to be representative of any number of circuit boards and digital components configured to provide additional functionality to the exemplary power meter 10. For example, option module 21 may comprise a communications module or personality module, as discussed in conjunction with FIG. 2 below, or other functionality-enhancing arrangement(s) of processors, microcontrollers, and/or related components.

At this juncture, the schematic exemplary representations of FIG. 2 will be addressed in greater. FIG. 2 illustrates highly simplified block diagrams of three exemplary utility meters, meter 10-1, meter 10-2, and meter 10-3. It will be understood by one of ordinary skill in the art that the representations 10-1, 10-2, and 10-3 stand for utility meters which may of course include other components, such as housings, power supplies, and various conventional apparatus, well known to those of ordinary skill in the art. Additionally, exemplary or representative utility meters 10-1, 10-2, and 10-3 will be discussed for the sake of convenience in the context of electricity metering, although it will be understood that such discussion is not meant to limit to electricity meters the technology disclosed herein; such technology is, rather, equally applicable to other types of utility meters.

Each illustrated representative utility meter 10-1, 10-2, and 10-3 includes a metrology module 12 configured to measure the utility of interest and to convert such measurement data into electronic form. As discussed above, for an electricity meter, a metrology module generally includes voltage and/or current data acquisition circuitry and additional circuitry configured to collect, manipulate, and route such data. The metrology module may be designed to calculate an energy measurement value, for example, watts consumed over a particular time interval.

Metrology module 12 for a particular meter (be it 10-1, 10-2, or 10-3 or some other embodiment) may be configured in accordance with the present subject matter to package the data it produces into a formatted message for transmission to other components of its corresponding utility meter. In FIG. 2, such formatted messages are represented with reference characters 14, 16, and 18 for meters 10-1, 10-2, and 10-3, respectively. Rather than formatting the message in a proprietary or device-specific manner, however, such data messages 14, 16, and 18 may be formatted in some other way in accordance with the present subject matter. For example, other alternative formats could be based on a particular industry practice, or other multi-party practices, or even customer practices.

Such alternatives may be based in part on a full protocol standard. For instance, such data messages can be generally formatted as if to comply with the ANSI C12.22 standard, which, as discussed above, specifies the “BLURT” one-way data message format. However, as recognized by the present subject matter, typical communications standards, such as ANSI C12.22, include so-called “overhead” related to preventing errors and mis-routings when communicating data. For instance, part of the ANSI C12.22 BLURT message format is the “Calling ApTitle,” which uniquely identifies the message source. However, in accordance with configurations which may be practiced per present subject matter, there may be situations in which the chance of an error in identifying the message source is minimized, or as a practicality, essentially nonexistent. Such may be the case with regard to exemplary representative utility meters 10-1, 10-2, and 10-3 of FIG. 2, since only one source (i.e. the metrology module 12) within any particular meter provides metrology data. Practically speaking, then, no identification of the metrology board to its corresponding associated module or modules is necessary for effective intra-meter communications of metrology data.

Therefore, in certain embodiments of the present subject matter, the data messages 14, 16, and 18 are formatted by or within the metrology board (generally 12) such that the data messages are partially compliant with a given communications standard, but omit portions that are unnecessary in accordance with the present subject matter for the particular arrangement of components. For example, the data messages may be formatted as ANSI C12.22 BLURT messages, but with the “Calling ApTitle” field nulled in whole or in part, or with the corresponding bytes omitted entirely from transmission from a given metrology module 12. In other present embodiments, other fields or portions of a message may be alternately removed or added, to result in partially compliant message formats or fully compliant message formats, respectively. The End Class Device portion of the message and/or the Write Service Request portion of the message format, are also examples of format portions or fields which may be included or not, in accordance with the present subject matter.

Use of an ANSI C12.22 BLURT message (or other suitable format) modified for example so as to omit unique source information especially provides advantages in the production and use of utility meters. For example, the same metrology module can be used as the base for multiple meters, as is illustrated in FIG. 2. Each representative meter 10-1, 10-2, and 10-3 has a different functionality profile provided via their respectively illustrated modules 20, 22, 24, and/or 26, but all such meters use an identical respective metrology module 12. The ability to omit source identification information in a message format allows for streamlined production of such metrology boards generally 12 since such metrology boards need not be programmed with unique identifiers during production of the utility meters.

Therefore, practice of the present subject matter advantageously results in improved utility meter manufacturing methodology, as well as improved methodology for operation of such utility meters.

An additional advantage to using an at least partially standards-compliant intra-meter message format is that interoperability with other modules may be enhanced. For instance, a utility meter manufacturer may produce meters comprising modules produced by the manufacturer alongside other modules produced by third parties. Use of a standardized intra-meter message format allows third-party module manufacturers to build standard modules, rather than a number of varieties of the same module, with each variety customized to operate within a particular manufacturer's meter, even though such meter itself is externally intended to operate in accordance with a particular communications protocol standard. The utility meter end-user also benefits, since third-party modules could be swapped between meters of various manufacturers, if need be.

Upon review of the present disclosure, those of ordinary skill in the art should understand that, for the case in which a standard message format is modified, the modules that receive such “modified” messages are correspondingly configured in accordance with the present subject matter to recognize the modified message format. For instance, in FIG. 2, the exemplary register module 20 of representative meter 10-1, the exemplary communications modules 22 and 26 of representative meters 10-2 and 10-3, respectively, and the exemplary personality module 24 of representative meter 10-3, are all programmed and otherwise configured per present subject matter to recognize the format of messages 14, 16, and 18, respectively.

The exemplary utility meters 10-1, 10-2, and 10-3 of FIG. 2 will now be discussed in more detail. Meter 10-1 illustrates a meter comprising a representative metrology module 12 linked to exemplary register module 20 such that message 14 may be transmitted between them, specifically, going from module 12 to module 20. Message 14 may comprise an ANSI C12.22 BLURT message with the ApTitle omitted per the present subject matter, and with exemplary register module 20 configured per present subject matter to recognize such message and decode the data contained therein. For instance, in an electricity meter, metrology module 12 may transmit in a periodic and timely fashion what may be thought of per present subject matter as “modified BLURT messages”, with each such message containing information such as measured current(s), voltage(s), and power consumed since the previous message. While such transmit time periods may constitute various times in various embodiments in accordance with broader aspects of the present subject matter, the transmit period for the “modified BLURT messages” in the present exemplary context (regarding an ANSI C12.22 BLURT message) is a little longer than 1 second. The broader consideration of the present subject matter is that such messages are periodic and timely. Exemplary register module 20 may decode such “modified BLURT messages”, and process the data to accumulate and provide a visual display of power usage. It is to be understood by those of ordinary skill in the art that such visual displaying or other forms of providing an output are to be regarded in the present context as transmitting or emitting such data or message, regardless of whether any actual wireless transmissions are involved.

Those of ordinary skill in the art will understand that the terminology “BLURT message” has a specific meaning in accordance with ANSI (American National Standards Institute) standard C12.22 and specifically how it addresses one-way messages. Therefore, use of “modified BLURT message” or more simply “modified message” will be understood by those of ordinary skill in the art as a coined terminology for a message in accordance with the present subject matter which in fact does not fully comply with a referenced standard (such as implied by use of the term “BLURT”) but which in some respects partially complies with the referenced standard communications protocol/data format. As also referenced above, such partially compliant message, in accordance with present subject matter, may be variously obtained, for example, by omitting one or more various format portions of a message. In accordance with the present subject matter, those may include as non-limiting examples, the above-referenced “Calling ApTitle” field and/or the “End Class Device” field and/or the “Write Service Request” field.

Exemplary utility meter 10-2 shows another meter configuration, in this case an exemplary metrology module 12 linked to an exemplary communications module 22. Exemplary communications module 22 may comprise any suitable device or system which is configured to link the representative utility meter 10-2 to a communications network. As shown here for exemplary purposes, communications module 22 includes a representative antenna for access to a wireless network. Such wireless networks may include, for example, radio, cellular or satellite telephone, or wireless data networks such as the type covered by IEEE standard 802.11. As in the case of representative meter 10-1, a metrology module 12, identical to that as usable with representative utility meters 10-1 and 10-3, may transmit present subject matter “modified BLURT messages” 16, which are received and processed by the representative communications module 22.

However, since in this example the representative communications module 22 is linked to a larger network, the “modified message” may undergo further processing (or at least to alter the format of the data per present subject matter) so as to render it standards-compliant for purposes of outside transmission (that is, transmission or dissemination external to the representative utility meter 10-2). For instance, the representative communications module 22 may be configured to recognize a “modified BLURT message” per present subject matter and to add per present methodology the unique identification information to transform “modified message” 16 into full-C12.22-compliant message 30 originating from exemplary utility meter 10-2, which is then transmitted onto a network. In other embodiments, the exemplary communications module 22 may additionally process a plurality of messages 16 rather than respectively convert such plural messages 16 into standards-compliant messages 30 on a one-to-one basis. In such present alternative embodiment cases, the exemplary communication module 22 may be configured to decode and process the internal (i.e., modified) “BLURT” messages 16 and to produce its own standard-compliant messages 30 or otherwise for transmission or dissemination external to exemplary utility meter 10-2.

Exemplary utility meter 10-3 includes two representative modules-a representative personality module 24 and a representative communications module 26. Intra-meter message 18 is shown as provided to both modules 24 and 26 from exemplary metrology module 12 in order to illustrate that messages may be provided in accordance with the present subject matter from a given metrology module (or other common location or source within a given meter) to a number of different modules, either simultaneously or sequentially.

Representative personality module 24 may include register capability, or may comprise an option board or other customization of a given utility meter, often as determined by the preferences of the customer, such as a power company or provider. For instance, in the case of an electricity meter, representative personality module 24 may allow for additional power measurement or storage capability, or may facilitate connection of the corresponding exemplary meter 10-3 to additional power system components, such as load control apparatus. In any event, such exemplary personality module 24 is configured to recognize and decode “modified message” 18, so as to result in access to the metrology data provided by exemplary metrology module 12. Those of ordinary skill in the art will appreciate the various uses which may be made of the further processed data or information derived from, or provided by, such personality module 24 technology, the details of which form no particular present subject matter. However, though not explicitly illustrated in detail herewith, it is to be understood that such data or information from personality module 24 may be further communicated within or without exemplary meter 10-3. If such further communication is within meter 10-3, then in accordance with present subject matter, a “modified” data format may continue (i.e., a format which is less than fully compliant with some communications protocol standard). However, if such further communication is outside of meter 10-3, then in accordance with present subject matter, a “modified” data format may be “unmodified” (i.e., so as to be a format which is fully compliant with some communications protocol standard).

For purposes of illustration only, representative communications module 26 is shown as hardwired to an external source, as would be the case for communications networks utilizing telephone, cable, or other modems, including broadband-over-powerline, or still other wire-based communications methodologies, such as Ethernet and direct connections. As stated previously regarding representative communications module 22, exemplary communications module 26 receives and decodes the intra-meter message 18 provided in accordance with the present subject matter. If the message 18 is to be relayed outside the representative meter 10-3, the exemplary module 26 adds the necessary information to produce a representative standards-compliant message 32. As illustrated in conjunction with either of exemplary utility meter 10-2 or 10-3, such standards-complaint message 32 may then be further transmitted or propagated in some fashion, in accordance with the present subject matter, via wired or wireless technologies, or via combinations of both, whether now existing or later developed, details of which form no particular aspects of the present subject matter.

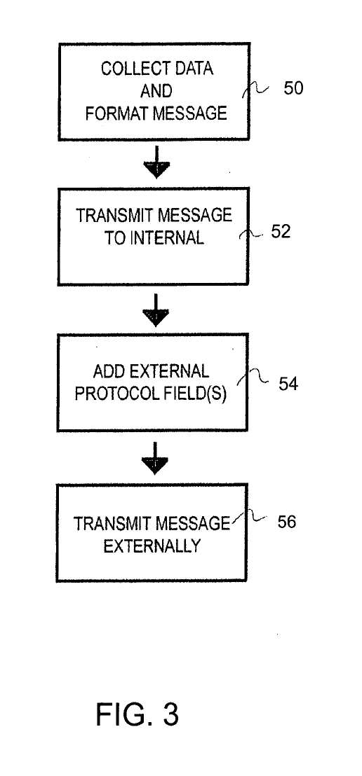

FIG. 3 illustrates an exemplary present methodology of relaying data between exemplary utility meter modules and then to a larger network. At representative step 50, data is collected and the subject message as formatted. As discussed above, data collection may be achieved, for example, using a metrology board configured to collect and/or derive data of interest (e.g. electricity, water, gas, or oil consumption measurement data). The metrology board can then format the data into a message format per present subject matter that at least partially complies with network standards, such as by omitting unique source identification. For instance, if message format comprises an ANSI C12.22 BLURT message, then in accordance with present subject matter, modified message data may be generated which is without the “Calling ApTitle” field. In additional present embodiments, the omitted field or fields may include combinations of various portions of the message, such as the “Calling ApTitle” field and/or the “End Class Device” field and/or the “Write Service Request” field.

Then, per representative step 52, a message formatted in accordance with present subject matter per representative step 50 is transmitted to another component or components within a given utility meter. As discussed in conjunction with FIGS. 1 and 2, such an exemplary present metrology board may be connected (in any appropriate manner) to other boards or modules that provide additional functionality to the given utility meter associated with such present metrology board, for example, such as by use of a connector interface.

Per present subject matter, for any modules which do not communicate outside the given meter in a standards-compliant manner, no further activity regarding message formatting is necessary. For instance, a present exemplary register module per the present subject matter can decode the message and perform operations on or otherwise use the data contained therein.

For those modules or components which connect to, or which are intended, using a standardized protocol, to connect to an outside network (i.e., a network outside of a given utility meter) such components per present representative step 54, can add information corresponding to that which was omitted when the message per the present subject matter originated at the metrology board. Subsequently, pursuant to representative present step 56, the resulting message may be transmitted or disseminated in a standards-compliant manner. For instance, for an intra-meter ANSI C12.22 “BLURT” message (i.e., one per present subject matter that for example omits the bytes corresponding to the unique “Calling ApTitle” field and/or the “End Class Device” field and/or the “Write Service Request” field ), those previously omitted bytes can be added to the message before its transmission. It should be appreciated that the “Calling ApTitle” (or other appropriate field(s)) may simply be added to the intra-meter message that is received—that is, the communications module need not decode the contents of the message, so long as the message that is ultimately transmitted or otherwise propagated is properly formatted per whatever communications protocol standard is being utilized. Alternatively, a module in accordance with present subject matter may decode and operate upon the data message itself before adding any formatting information as required to render the resulting data standards-compliant. As a further exemplary alternative, the double-headed arrow (see lead line 25) of example 10-3 of FIG. 2 is intended to represent the alternative application of the personality module 24 receiving a message from the exemplary metrology module 12 and modifying it before it is made available to the communications module 26. In other words, the double-headed arrow 25 represents that the message may first flow from metrology module 12 to personality module 24 for modification, and thereafter such modified message flow from personality module 24 to communications module 26 for transmission. In such alternative, communication module 26 is not modifying or adding to the message, but the personality module 24 is modifying or generating a new compliant or modified message for use by or with communication module 26.

Those of ordinary skill in the art will appreciate that the formatting, processing, transmission, reception, and/or other data operations discussed herein may be achieved using either of hardware or software-based implementations, such as variously comprising microcontrollers, microprocessors, memory devices, and/or other appropriately configured and programmed electronics, or various combinations of the foregoing, whether now or later developed, and that the methods and systems for data transmission and manipulation discussed herein are not meant to be limited to nor specific to particular hardware module implementations nor specific to particular communications protocol standards. In other words, it should be appreciated by those persons of ordinary skill in the art that the present subject matter is not limited by what has been particularly shown and described above. Rather, it is intended that the scope of the present subject matter includes both combinations and sub-combinations of various features discussed herein, along with such variations and modifications as would occur to a person of ordinary skill in the art. Thus, while the present subject matter has been described in detail with respect to specific embodiments thereof, it will be appreciated that those of ordinary skill in the art, upon attaining an understanding of the foregoing, may readily produce alterations to, variations of, and equivalents to such embodiments, wherefore the scope of the present disclosure and appended claims is by way of example rather than by way of limitation, and it does not preclude inclusion of such modifications, variations and/or additions to the present subject matter as would be readily apparent to one of ordinary skill in the art.

What is claimed is:

1. A utility meter, which makes modified use of ANSI standards for internal communications, but which makes use of normal ANSI standards for external communications, for interaction with an ANSI standards-based network, said utility meter comprising:
a metrology board, having a modified ANSI C12.22 BLURT message output which omits preselected device-specific data, for internal transmissions to other components within said meter; and
at least one other component within said meter, and comprising one of a register board, personality module, options module, or communications module, said at least one other component adapted for receiving said modified ANSI C12.22 BLURT message output of said metrology board, and processing said modified ANSI C12.22 BLURT message for emission external to said meter.

2. A utility meter as in claim 1, wherein said at least one other component within said meter is adapted for receiving said modified ANSI C12.22 BLURT message output of said metrology board, and including therewith device-specific data so as to create a fully formatted ANSI standards compliant message, for transmission external to said meter along an ANSI C12.22 rated network.

3. A utility meter as in claim 2, wherein said modified ANSI C12.22 BLURT message output contains a modified ApTitle.

4. A utility meter as in claim 3, wherein said modified ApTitle of said modified ANSI C12.22 BLURT message output comprises one of a null ApTitle and a fully omitted standard ApTitle.

5. A utility meter as in claim 2, wherein said utility meter comprises one of an electricity meter, a water meter, a gas meter, or oil consumption meter.

6. A utility meter as in claim 2, wherein said modified ANSI C12.22 BLURT message output omits a “Calling ApTitle” field.

7. A utility meter as in claim 2, wherein said modified ANSI C12.22 BLURT message output omits an “End Class Device” field.

8. A utility meter as in claim 2, wherein said modified ANSI C12.22 BLURT message output omits a “Write Service Request” field.

9. A utility meter as in claim 1, wherein:
said utility meter comprises one of an electricity meter, a water meter, a gas meter, or oil consumption meter;
said at least one other component within said meter is adapted for receiving said modified ANSI C12.22 BLURT message output of said metrology board, and including therewith device-specific data so as to create a fully formatted ANSI standards compliant message, for transmission external to said meter along an ANSI C12.22 rated network; and
said modified ANSI C12.22 BLURT message output omits at least one of the Calling ApTitle field, the End Class Device field, and the Write Service Request field omitted entirely.

10. A metrology system, comprising:
a first device configured to collect data corresponding to utility consumption data; and
a second device configured to receive data from said first device using a fully-compliant standard communications protocol;
wherein said first device comprises a plurality of component subsystems configured for communications among themselves using a non-fully compliant standard protocol subset of the fully compliant standard protocol.

11. A metrology system as in claim 10, wherein said plurality of component subsystems are configured to namelessly communicate among themselves.

12. A metrology system as in claim 11, wherein said plurality of component subsystems comprise a metrology subsystem and at least one other subsystem selected from the group consisting of a register subsystem, a personality subsystem, an options subsystem, and a communications subsystem.

13. A metrology system as in claim 12, wherein said at least one other subsystem comprises a communications subsystem configured to convert nameless communications from said metrology subsystem to a fully compliant standard communications protocol for external transmission thereof to said second device.

14. A metrology system as in claim 13, wherein said communications subsystem is configured to receive a plurality of non-fully compliant communications from said metrology subsystem and to process the plurality of communications of non-fully compliant communications so as to provide a fully compliant standard communications protocol message for external transmission thereof to said second device.

15. A metrology system as in claim 12, wherein said metrology subsystem is configured for providing data corresponding to one of electricity, water, gas, or oil consumption measurement data.

16. A metrology system as in claim 10, wherein:
said plurality of component subsystems are configured to namelessly communicate among themselves;
said plurality of component subsystems comprise a metrology subsystem and at least one other subsystem including a communications subsystem configured to convert nameless communications from said metrology subsystem to a fully compliant standard communications protocol for external transmission thereof to said second device; and
said metrology subsystem is configured for providing data corresponding to one of electricity, water, gas, or oil consumption measurement data.

17. A method for providing fully compliant standard protocol inter-communications among plural associated devices, comprising:
providing a plurality of devices, each device comprising a plurality of subsystems, at least one selected subsystem of each respective device having communications capabilities with one or more of the other subsystems in each such respective device;
selecting a standard communications protocol for communications among the plural associated devices, the standard communications protocol including plural segments;
transmitting data among subsystems of each device using a non-fully compliant standard protocol subset of the plural segments of the selected standard communications protocol;
combining data with the non-fully compliant standard protocol subset to produce a fully compliant standard protocol message for each respective device; and
transmitting the fully compliant standard protocol message externally from each respective device.

18. A method as in claim 17, wherein the step of providing a plurality of devices comprises:
providing a metrology module for each respective such device; and
providing at least one additional module for each respective such device;
wherein communications between each such metrology module and each associated at least one additional module is conducted using the non-fully compliant standard protocol.

19. A method as in claim 18, wherein the step of transmitting data among subsystems of each device comprises transmitting data omitting source identification.

20. A method as in claim 19, wherein:
the step of selecting a standard communications protocol for communications among the plural associated devices comprises selecting the ANSI C12.22 BLURT standard communications protocol; and
wherein transmitting data omitting source identification comprises transmitting messages with the Calling ApTitle field modified.

21. A method as in claim 20, wherein transmitting data omitting source identification comprises transmitting messages with the Calling ApTitle field modified by one of nulling such field at least in part and omitting such field entirely.

22. A method as in claim 18, wherein providing a metrology module for each respective device comprises providing a metrology board therefor configured to provide data corresponding to one of electricity, water, gas, or oil consumption measurement data.

23. A method as in claim 18, wherein providing at least one additional module for each respective device comprises providing at least one module therefor selected from the group comprising register modules, personality modules, and communications modules.

24. A method as in claim 17, wherein the step of transmitting data among subsystems of each device comprises:
transmitting plural non-fully compliant standard protocol messages among selected subsystems of each respective device; and
converting the plural messages to a single non-fully compliant standard protocol message.

25. A method as in claim 17, wherein the step of combining data with the non-fully compliant standard protocol subset comprises associating source identification data with the non-fully compliant standard protocol message.

26. A method as in claim 17, wherein:
the step of providing a plurality of devices comprises providing a metrology module for each respective such device with each such metrology board configured to provide data corresponding to one of electricity, water, gas, or oil consumption measurement data, and providing at least one additional module for each respective such device with such at least one module selected from the group comprising register modules, personality modules, and communications modules, so that communications between each such metrology module and each associated at least one additional module is conducted using the non-fully compliant standard protocol;
the step of transmitting data among subsystems of each device comprises transmitting data omitting source identification;
the step of selecting a standard communications protocol for communications among the plural associated devices comprises selecting the ANSI C12.22 BLURT standard communications protocol; and
the step of combining data with the non-fully compliant standard protocol subset comprises associating source identification data with the non-fully compliant standard protocol message.

27. A communications system, comprising:
a first device comprising a plurality of component subsystems; and
a second device, said first and second devices configured for communications using a fully compliant standard protocol,
wherein the plurality of component subsystems of said first device are configured for communications among themselves using a non-fully compliant standard protocol subset of the fully compliant standard protocol.

28. A communications system as in claim 27, wherein said plurality of component subsystems of said first device comprise a metrology subsystem and at least one other subsystem selected from the group consisting of a register subsystem, a personality subsystem, an options subsystem, and a communications subsystem.

29. A communications system as in claim 28, wherein said metrology subsystem is configured to namelessly communicate with one or more of said other subsystems.

30. A communications system as in claim 28, wherein said metrology subsystem comprises a metrology subsystem configured to provide data corresponding to one of electricity, water, gas, or oil consumption data.

31. A communications system as in claim 27, wherein said fully compliant standard protocol corresponds to the ANSI C12.22 BLURT protocol.

32. A communications system as in claim 31, wherein said plurality of component subsystems of said first device are configured for communications among themselves by transmitting messages with the Calling ApTitle field modified.

33. A communications system as in claim 32, wherein said plurality of component subsystems of said first device are configured for communications among themselves by transmitting messages with the Calling ApTitle field modified by one of nulling such field at least in part and omitting such field entirely.

34. A communications system as in claim 31, wherein said plurality of component subsystems of said first device are configured for communications among themselves by transmitting modified messages, with at least one of the Calling ApTitle field, the End Class Device field, and the Write Service Request field omitted entirely.

35. A communications system as in claim 27, wherein:
said plurality of component subsystems of said first device comprise a metrology subsystem and at least one other subsystem selected from the group consisting of a register subsystem, a personality subsystem, an options subsystem, and a communications subsystem;
said metrology subsystem is configured to provide data corresponding to one of electricity, water, gas, or oil consumption data, and is configured to namelessly communicate with one or more of said other subsystems;
said fully compliant standard protocol corresponds to the ANSI C12.22 BLURT protocol; and
said plurality of component subsystems of said first device are configured for communications among themselves by transmitting modified messages.
